(19) United States
(12) Patent Application Publication
(10) Pub. No.: US 2012/0059851 A1
(43) Pub. Date: Mar. 8, 2012

(54) Function-Oriented Mapping of Technological Concepts

(76) Inventors: Hans Lercher, Fernitz (AT); Manfred Peritsch, Baden (AT)

(21) Appl. No.: 13/040,334

(22) Filed: Mar. 4, 2011

Related U.S. Application Data
(60) Provisional application No. 61/310,830, filed on Mar. 5, 2010.

(51) Int. Cl. G06F 17/30

(52) U.S. Cl. 707/780; 707/E17.014

(57) ABSTRACT

A method of mapping technologies relating to a technical database to a technical system, wherein the method comprises describing the technical system by at least one function, abstracting the at least one function by determining at least one system function, deriving, for each of a plurality of reference documents of the technical database, a corresponding set of at least one reference function indicative of at least one function of the respective technology, and querying the sets of at least one reference function with regard to the at least one system function to determine a match between at least one respective technology and the technical system.

The invention relates to a method of mapping technologies (relating to a technical database) to a technical system.

Moreover, the invention relates to an apparatus for mapping technologies (relating to a technical database) to a technical system.

Beyond this, the invention relates to a program element.

Furthermore, the invention relates to a machine-readable medium.

There is a need in basically all technical fields to continuously innovate technical systems to meet the requirements of the quick technological development all over the world. At the same time, innovation cycles of a technical system become shorter and shorter. However, conventional concepts of improving technical systems by combining different technical approaches taken in a specific technical field have been exhausted.

One conventional concept of innovating a technical system is to make use of the ideal final result (IFR) method. As disclosed in http://www.trizjournal.com/content/c061128a.asp, IFR is one of the tools used during the problem definition phase of TRIZ (Theory of Inventive Problem Solving). It describes a solution to a problem free of any mechanisms or constraints from the original problem or issue. This is similar to “re-engineering” in the process management world, in which processes are “blown-up” and revamped. One may think of it as an ideal end-state without any strings attached from the current issue one is facing.

The IFR is a solution to a problem with the benefits this result delivers. The IFR sets the stage for the continued use of TRIZ tools by focusing on well-defined problems with a clear visualization of the ideal result. The primary benefit of the IFR is its problem solving attributes. The IFR encourages “outside of the box thinking,” by removing real or perceived barriers, while offering alternate solution paths. The IFR does this by starting with perfection, disconnecting any limitations associated with current issues. This way of thinking allows for breakthrough solutions by discouraging settling for less than ideal solutions.

US 2009/0271701 A1 discloses a method for systematically identifying technology based solutions, wherein technical components for particular technical systems are identified, as well as the corresponding technological functions associated with the identified technical components. Further, development obstacles may be identified and a set of potential solutions corresponding to the identified obstacles may then be generated using information access from one or more technology databases.

However, it is conventionally difficult to properly face the challenge of continuously improving technical systems, since research and development departments appear in many cases to be trapped in their own minds.

It is an object of the invention to provide an efficient way of further developing technical systems.

In order to achieve the object defined above, a method of mapping technologies relating to a technical database to a technical system, an apparatus for mapping technologies relating to a technical database to a technical system, a program element, and a machine-readable medium according to the independent claims are provided.

According to an exemplary embodiment of the invention, a method of mapping (or transferring) technologies—relating to a technical database—to a technical system is provided. The method may comprise describing the technical system by at least one function (particularly by a plurality of functions), and abstracting (or generalizing) the at least one function by determining at least one system function (particularly a plurality of system functions, each of which corresponding to a respective one of the functions). The method may further comprise deriving, for each of a plurality of reference documents of the technical database, a corresponding set of at least one reference function (particularly a plurality of reference functions) indicative of at least one function (particularly of a plurality of functions) of the respective technology (particularly, each reference document may relate to an assigned one of the technologies). Furthermore, the sets of at least one reference function may be queried (or searched) with regard to the at least one system function to determine a match between at least one respective technology and the technical system (particularly, it may be possible to search for the at least one system function in the sets of at least one reference functions, and/or vice versa).

According to another exemplary embodiment of the invention, an apparatus for mapping technologies relating to a technical database to a technical system is provided, the apparatus comprising a technical system data input unit adapted for receiving technical system data indicative of at least one function of the technical system abstractly described by at least one system function, a deriving unit adapted for deriving, for each of a plurality of reference documents of the technical database, a corresponding set of at least one reference function indicative of at least one function of the respective technology, and a querying unit adapted for querying the sets of at least one reference function with regard to the at least one system function to determine a match between at least one respective technology and the technical system.

According to still another exemplary embodiment of the invention, a program element (for instance a software routine, in source code or in executable code) is provided, which, when being executed by a processor (such as a microprocessor or a CPU), is adapted to control or carry out a method having the above mentioned features.

According to yet another exemplary embodiment of the invention, a machine-readable medium, particularly a computer-readable medium, (for instance a CD, a DVD, a USB stick, a floppy disk or a harddisk) is provided, in which a program is stored which, when being executed by a processor (such as a microprocessor or a CPU), is adapted to control or carry out a method having the above mentioned features. In this context, a machine may particularly be a computer such as a desktop computer or a laptop. However, a machine may also be a tablet device, a mobile phone (particularly a smart phone), a personal digital assistant or any other device which has processing capabilities.

Data processing which may be performed according to embodiments of the invention can be realized by a machine-readable program (for instance a computer program), that is by software, or by using one or more special electronic optimization circuits, that is in hardware, or in hybrid form, that is by means of software components and hardware components.

In the context of this application, the term “mapping technologies” (or intertechnologically transferring technical solutions) may particularly denote a concept of analyzing technologically far-off solutions from different technological fields in order to apply such solutions to a predefined technical system. Hence, in fundamental contrast to conventional approaches, the strategy is not to simply copy known solutions from the same or a closely related technical field on the basis of a concrete technical problem to be solved, but to map far-off solutions to a present technical scenario by abstracting technical effects on a functional basis. However, it is also possible to analyze technologically close solutions from the same, a similar or a neighbored technological field in order to apply such a solution to a predefined technical system.

The term “technical database” may particularly denote an accessible and preferably machine-readable collection of data regarding preknown technical knowledge. Such a technical database may comprise a number of prior art documents, for instance in electronic form, which allows to perform a search on the basis of keywords, synonyms, semantics, or context-related search strategies. The technical database may be constituted by a large number of reference documents each describing a technical reference subject.

The term “technical system” may particularly denote a physical body, a technical device, an arrangement of multiple technical devices, or a virtual concept such as a technical method (for instance a manufacturing method, an operation method, etc.) or a process or a procedure. The technical system may already exist, either physically (for instance in the form of a commercially available object, a prototype, a plant, etc.) or mentally (for instance in the form of an engineering drawing, a proof-of-concept model, a theoretical concept, etc.). This existing technical system may be subject to a database-assisted further development performed in the context of an innovation process. Thus, a functional improvement of the technical system based on technical considerations may be the object of the innovation (this may also cover the addition of new functions and/or the elimination of existing functions). However, it is also possible that a desired, non-existing technical system to be developed is defined by means of one or more desired functions the technical system shall fulfill.

The term “function” may particularly denote a technical function provided by an existing technical system (being further developed) or a part thereof. A function may be generally denoted as an effect achieved by an object. If the technical system is newly developed, i.e. is not yet existent, the term “function” may also denote a technical target function which a user desires the technical system to fulfill after being readily developed. Accordingly, the term “system function” may particularly denote a generalized or abstracted function as compared to a corresponding “function”, i.e. what is obtained when generalizing or abstracting an above-defined function. As an example, if the function of a glove is “protecting hands”, a corresponding system function could be “protecting biological surfaces”. The term “function model” may particularly denote any model which is based on the definition of one or more functions to be provided by a system. Embodiments of the invention may be based on such a function model as a starting point for the further retrieval of technologies being suitable for the creation or improvement of a technical system.

The term “system model” may particularly denote a virtual or logical description of the system (for instance comprising or consisting of the technical system) which can be logically represented by cooperating blocks (also denoted as system elements) linked or interconnected to one another via system functions reflecting the functional interaction between these blocks. A system model can be considered as an exemplary representation of a function model.

The term “abstracting” may particularly denote a process of raising a specific function from a concrete level to a more generalized function on an abstract level. The abstracting may decouple a concrete function described in terms of a concrete technology to an abstract function detached from this concrete technology. For instance, a rubber fulfils the task to remove a line produced by a pencil. Hence, a concrete function would be to erase a line produced by a pencil. A corresponding abstracted function could be to delete a sign.

The term “determine a match” may particularly denote that, on a higher abstract level than the level of concrete functions, i.e. on an abstracted functional level, a sufficient degree of concordance or compliance between the abstracted function of the technical system on the one hand and a corresponding one of the sets of one or more reference functions of the reference documents in the reference database has been found. Such a matching may comprise a comparison of system functions with sets of reference functions to identify those sets which show a sufficient similarity. For instance, criteria for a match can be that a percentage of the consistent functions of technical system and reference document exceeds a predefined threshold value. Additionally or alternatively, a criteria for a match can be that a consistence of a sub-set of key functions of technical system and reference document, which are considered as particularly relevant, exceeds a predefined threshold value. Additionally or alternatively, a criteria for a match can be that a reference document provides technical teaching to overcome at least one harmful function (i.e. disadvantageous or undesired effects) of the technical system while at the same time showing sufficient degree of correspondence between functions (i.e. advantageous or desired effects) of technical system and reference document. In one embodiment, there can be a single match, for instance when searching for the best match (for instance a match for which the least mean squares value is minimum). In another embodiment, there can be multiple matches which can be output as a basis for the further innovation process of the technical system, for example in a certain order in accordance with the degree of similarity.

According to an exemplary embodiment of the invention, a concept is provided which allows supporting or promoting a development or an innovation process performed by any user such as an engineer or a research and development group with a for instance computer-based development or innovation tool. The concept may be based on the description of a technical system under development or further development by its function or functions it provides. Then, the function(s) of the technical system may be transferred to a higher hierarchical abstract level in the form of one or more system functions. Moreover, multiple technical reference documents may be analyzed for extracting their concrete function(s). Optionally, also this or these reference function(s) may be abstracted, i.e. transferred to a higher logical hierarchical level before comparison with the system function(s). Subsequently, it is possible to perform a matching by comparing one or more functions on a level of abstraction which is higher than a level of abstraction used for engineering within a certain technology. This allows overcoming technological barriers for finding functionally applicable solutions in other technical fields. Therefore, in contrast to the usual approach of users of looking for similar solutions exclusively in similar technical fields, an embodiment of the invention transfers both the function(s) of the technology under considerations as well as the function(s) provided by technologies of reference documents to a higher abstract functional level to compare it on this higher level. On this higher level, matches between technically different but functionally similar concepts may be found much easier since this functional view is free of technology-related constraints. A result of such a functional analysis can be supplied to the user (for instance an engineer or the research and development group) for finalizing the development process by adapting the solutions from the for instance far off technological field to the technical system. Such a concept can serve as a powerful tool for innovating regardless of the definition of a concrete technical object to be solved. Disregarding a specific object allows to innovate on a functional basis which opens the view to, prima facie, very different concepts which however share a sufficiently similar functional concept when considered from an abstract point of view. This may simplify the finding of cross-industry or cross-technology solutions. Furthermore, such a concept may promote the finding of disruptive technologies which do not only provide a small improvement within one technological field but also allow for paradigm shifts. By abstracting the function(s) to derive the system function(s), the look-up field of considered technologies is increased without introducing a priori irrelevant technologies, since their relevance is in fact dependent on a similarity of functions.

In the following, further exemplary embodiments of the method will be explained. However, these embodiments also apply to the apparatus, to the machine-readable medium and to the program element.

In some cases, multiple functions will be necessary for appropriately describing a technical system. However, for instance in the context of autarkic or self-controlling systems, one function may be sufficient (as well as one system element may be sufficient in an optional system model). An example would be a self-cleaning windscreen of a vehicle. In contrast to a conventionally cleaned windscreen in which the function “clean windscreen” is provided by a wiper, a self-controlling system may be a windscreen which cleans itself, for instance by means of a dirt-repellent coating. In such a scenario, a system element acts on itself.

In an embodiment, the technical system to be further developed may be an existing technical system of an existing technical system generation which is to be re-innovated for a future technical system generation. Thus, the system may be used for supporting a user such as an engineer in technically further developing a technical system. In contrast to conventional concepts in engineering, embodiments of the invention do not only rely on the adaptation or application of known concepts in related technical fields, but re-define desired functional requirements on a logically abstract functional level, thereby getting access to very different technical fields which relate to complete different technologies but having similar abstract functional boundary conditions.

In an embodiment, the method comprises describing the technical system by a system model constituted by one system element or a plurality of interacting system elements, and abstracting the interaction of the one or more system elements by determining the at least one system function. Thus, a system model which logically decomposes or structures the technical system into multiple system elements representing blocks of the technical system may be defined.

In an embodiment, the reference documents of the technical database may comprise technical specifications relating to intellectual property rights (such as patent applications, patents, utility models, design models, mask work protection rights, plant variety rights, etc.), scientific articles (scientific papers, conference contributions, white papers), operation instructions (for instance a manual for using the technical system) and/or technical specifications published via a communications network (such as the public Internet or an intranet). Any electronically accessible technical database may be used as a basis for searching for existing technologies providing similar or identical functional solutions for other purposes.

In an embodiment, at least a part of the technologies relating to the technical database may be from another technical field, particularly from another International Patent Classification (IPC) class, more particularly from another IPC main class, than the technical system to be further developed. In contrast to conventional and obvious IP search strategies focusing on similar or identical IPC classes only, the described embodiment of the invention takes a fundamentally different approach and looks for functional similarities in completely different technical fields. This allows an engineer to consider very different technical concepts and therefore to further develop the technical system off the beaten tracks in the present technical field. In a further embodiment, the technologies considered for matching may be limited to those from another IPC main class. This may filter out already known concepts from the technical field the technical system belongs to and may open the view for revolutionary concepts.

In an embodiment, the system elements may comprise innovatable system elements being modifiable (for instance during an innovation process of innovating an existing technical system, or during a development process of newly developing a technical system), and comprise fixed system elements remaining fixed (for instance during an innovation process of innovating an existing technical system, or during a development process of newly developing a technical system). Thus, for instance defined by an engineer or any other user, some of the system elements may be defined as unalterable during the innovation process. This may correspond to boundary conditions which need to remain as they are, for instance due to safety reasons, legal compliance, interoperability with other components of a machine or plant, etc. Thus, it may be safely prevented that the cross-system technology combination disregards particularities of the technological field of the technical system to be (further) developed. Remaining system elements may be considered as design parameters for innovating and transferring solutions.

In an embodiment, the system elements may comprise structural system elements indicative of a physical structure of a part of the technical system, and comprise peripheral system elements indicative of a periphery of a physical structure of the technical system. Structural system elements may relate to a specific member or group of members such as the “brake system of a vehicle”. Peripheral system elements may relate to virtual or physical blocks of the technical environment in which the technical system operates such as a “human driver” driving the vehicle or “roads” on which the vehicles drive. It is possible that peripheral system elements are classified as fixed system elements because their modification could have a negative impact on the universal usability of the technical system. It is possible that structural system elements are classified as fixed system elements or as innovatable system elements, in dependence of design conditions.

In an embodiment, each of the one or more system functions may link or logically connect at least two of the system elements. In an embodiment, a system function may be considered as some kind of vector pointing from a controlling (active) system element to a controlled (passive) system element and having, as some kind of content, the function provided from the controlling (active) system element to a controlled (passive) system element.

In an embodiment, the sets of one or more reference functions may be derived by searching the reference documents, particularly by processor-based file searching in the reference documents. This may include any kind of database search, including keyword search, search considering synonyms, content-based search, search involving semantic tools, etc. The extractions of functions provided by a technology can be performed by a search machine in an automated manner, using algorithms known as such to those skilled in the art. For instance, elements of artificial intelligence may be implemented for this purpose such as Fuzzy logic, neural networks, adaptive concepts.

In an embodiment, the method may further comprise describing the technical system by one or more harmful functions (such as negative functions undesired functions or shortcomings), abstracting (or generalizing) the one or more harmful functions by determining one or more harmful system functions, and querying the sets of one or more reference functions with regard to the one or more harmful system functions to determine one or more respective technologies overcoming one or more of the one or more harmful system functions of the technical system. Thus, for the matching of harmful functions, an inverse matching concept may be applied. i.e. reference documents which do not show the harmful functions may be considered as particularly appropriate candidates for a match. In other words, the opposite function to a harmful function of the technical system should be searched in such a concept. For instance, if a turbine generates noise (which is an example for a harmful function), functions suppressing or eliminating noise can be searched.

In an embodiment, the method may further comprise abstracting the interaction of the plurality of system elements by determining one or more harmful system functions, and querying the sets of reference functions with regard to the one or more harmful system functions to determine at least one respective technology overcoming at least one harmful system function of the technical system to be (further) developed. In addition to desired functions provided by the technical system, it is also possible to consider one or more harmful functions (such as negative functions or undesired functions or shortcomings) of the technical system which are desired to be suppressed or eliminated by the innovation process. Thus, the mapping and matching process may be performed simultaneously with the goal to obtain a sufficiently high match regarding functions of the technical system and the reference technology as well as a sufficient match of the inverse (or the contrary) of the harmful function of the technical system and a corresponding function of the reference technology. In other words, according to an embodiment, a match may require not only a sufficient correspondence of the positive functions. It may additionally be required for the recognition of a match that the reference technology allows to overcome one or more shortcomings (harmful functions) of the technical system.

Additionally or alternatively, the method may comprise deriving, for at least a part of the plurality of reference documents of the technical database, a corresponding set of one or more harmful reference functions indicative of harmful functions (such as negative functions or undesired functions or shortcomings) of the respective technology. Furthermore, it is possible to consider the harmful reference functions when querying the sets of reference functions to determine a match. To simplify the matching procedure, also harmful functions of the reference technology may be extracted by searching these documents. For instance, a scientific paper might indicate both advantages and disadvantages of the published subject-matter. This may prevent the generation of a match due to a sufficient agreement between functions of technical system and reference technology although the reference technology suffers from technical problems which the technical system has already overcome or desires to overcome during the innovation.

In an embodiment, the method may comprise selecting and outputting a sub-set of best matching of the plurality of the reference documents. The result of the matching procedure, which may use conventional matching algorithms known to a person skilled in the art, may be displayed to a user. The manner of displaying may be in accordance with an order of the degree of matching. For instance, the best match may be displayed first, followed by the second best match, and so on. To quantify the degree of the match, a credit may be awarded for each match. For instance, each corresponding function may obtain a first credit value, each function of the reference document corresponding to a harmful function may obtain a second credit value (which may larger than the first credit value). It is also possible that a relevance is quantified for some functions or each function (and optionally for some harmful functions or each harmful function), and that the awarded credit is determined in accordance with this relevance.

In an embodiment, the method may comprise classifying the one or more determined system functions in accordance with a plurality of predefined function classes each of which being indicative of a level of satisfaction with (or an acceptance of) a corresponding system function, and selecting and outputting a sub-set of at least one best matching of the plurality of the reference documents which allows at least one of the system functions to be converted to a higher level of satisfaction. Still referring to the previously described embodiment, the function classes may comprise a complete satisfaction level indicative of a complete satisfaction with a corresponding system function, a partial satisfaction level indicative of a partial satisfaction with a corresponding system function, and a dissatisfaction level indicative of a dissatisfaction with (or a non-acceptance of) a corresponding system function. Other ways of classifying are of course possible as well.

It may be possible to distinguish between different types of functions and system functions, for instance to distinguish between positive functions and negative functions. Negative functions may be harmful functions or may be undesired functions. Positive functions may be useful functions or may be desired functions. Functions may also describe a degree according to which a task is fulfilled, for instance properly fulfilled, over-fulfilled (i.e. superfluous degree of fulfilling a task), or under-fulfilled (i.e. inadequate degree of fulfilling a task). Hence, in an embodiment, the term “function” may be a generic term including different kinds or types of functions such as useful functions and harmful functions.

In an embodiment, the system model may be determined based on a combination of the technical system and a technical document assigned to the technical system. Thus, the basis of data may be further broadened by including not only the technical system as a source of forming the system model, but also a corresponding electronic document including technical information regarding the technical system for the mapping procedure. If the technical system is legally protected by a patent, the patent document may be additionally used as a basis for determining data for refining the system model. This may allow using the technical document for deriving or extraction modeling information in a processor-based scan or analysis. This may simplify the generation of the system model in a computer-based way. Alternatively, a user may input data for the system model.

Still referring to the previously described embodiment, the technical document assigned to the technical system may comprise intellectual property rights (such as patent applications, patents, utility models, design models, mask work protection rights, plant variety rights, etc.), scientific articles (scientific papers, conference contributions, white papers), operation instructions and/or technical specifications published via a communications network (such as the public Internet or an intranet). Any electronically accessible technical database may be used as a basis for providing information with regard to the functional performance of the technical system.

In an embodiment, the method may comprise modifying the technical system to be (further) developed based on the determined match to thereby obtain an innovated technical system. Thus, the result of the analysis may be used for technologically improving the technical system. This may be realized by an engineer and/or by a computer system providing a proposal for a technical implementation of the matching technology with the technical system to be (further) developed. For instance, in a scenario in which replacement of a system element of the technical system by another system element from a matching reference technology allows improving the corresponding system function and/or suppresses or eliminates a harmful system function.

In an embodiment, the method may comprise determining a match under consideration of at least one predefined relevance criteria. An engineer may define the relevance of individual functions and/or harmful functions in a qualitative or quantitative manner. Based on such a user input, the matching may weight the importance of matching/non-matching criteria. Other criteria may also be implemented.

Thus, it is also possible to identify intellectual property of other technological fields which might be of interest for the own technical field. In a similar manner, it is also possible to identify own intellectual property which might be of interest for other technological fields. This can be a powerful tool for the basis of cross-licensing or the like.

Thus, in addition to the contribution to the innovation process, it is also possible that the exemplary embodiments of the invention allow for a function oriented IP management. Functions which are important for technological solutions may be taken as a starting point. The comparison of these functions to functions from other technological fields allow to easily find new technological solutions from other technological fields which, in the conventional way of solving problems by engineers, are not properly accessible. It is also possible to simply analyze future development or functions.

In this context, it is possible to distinguish different classes of functions. Main functions and auxiliary functions may be separated and may be considered with different relevance weights. With regard to harmful functions or undesired functions, it is also possible to classify, for instance to distinguish between avoidable harmful functions and unavoidable harmful functions.

The method may comprise abstracting the one or more reference functions before determining a match between at least one respective technology and the technical system to be (further) developed. A similar procedure may also be applied to harmful reference functions. It may be possible that also the reference functions are formulated in the technical database in the context of a specific technology. The probability to find a meaningful match between system functions/harmful system functions on the one hand and reference functions/harmful reference functions on the other hand can be further increased by raising the reference functions/harmful reference functions to a higher abstract level before executing the comparison, mapping, fitting or matching routine. For instance, a specific system function of a dental drill of a trephine may be to remove tooth material. A corresponding abstracted system function of the dental drill of the trephine could be to “remove material”. For instance, a specific reference function of a tunnel borer may be to “remove rock material”. A corresponding abstracted reference function of the tunnel borer could be to “remove material”. Hence, the probability of finding corresponding functions in different technical fields may be significantly increased by abstracting at least one of the system function(s) and the reference function(s), preferably both.

The method may comprise, when determining a match between at least one respective technology and the technical system to be (further) developed, considering a quantity of one or more system functions which do not match to reference functions. Even if there is a significant match between some of the system functions and some of the reference functions of a specific set, the fact that a significant number (for instance a number exceeding a predefined threshold) of system functions does not have a corresponding reference function may be a considered by the matching procedure as an indication that a specific technology cannot provide a powerful innovation contribution to the technical system to be (further) developed. Particularly, the system or a user may define one or more key system functions which are of fundamental importance for the technical system. If one or a predefined amount of such key functions is not provided by a reference technology (for instance does not have a corresponding reference function), the corresponding reference technology may be rejected, or the tendency that such a reference technology is considered as a match may be reduced. For instance, a ranking of such a reference technology may be downgraded in such a scenario. Hence, a decision criterion during the evaluation of the matching may be a number of non-matching functions. This may prevent the consideration of reference technologies which have some similarities with the technical system to be (further) developed but differ with regard to essential aspects.

According to an embodiment the technical system is a technical system to be further developed or is a technical system to be newly developed.

According to an embodiment the technical system to be further developed is an existing technical system of an existing technical system generation which is to be re-innovated for a future technical system generation.

According to an embodiment the method comprises abstracting an intereaction of the plurality of system elements by determining the at least one system function.

According to an embodiment the at least one system function indicates an influence of one system element on another system element.

According to an embodiment the sets of at least one reference function are derived by searching the reference documents, particularly by processor-based file searching in the reference documents.

According to an embodiment the method comprises selecting and outputting a sub-set of one or more best matching of the plurality of the reference documents.

According to an embodiment the method comprises classifying the at least one determined system function in accordance with a plurality of predefined function classes each of which being indicative of a level of acceptance of a corresponding system function in the technical system; selecting and outputting a sub-set of best matching of the plurality of the reference documents which allow at least one of the at least one system function to be converted to a higher level of acceptance.

According to an embodiment the function classes comprise a complete acceptance level indicative of a complete acceptance of a corresponding system function, a partial acceptance level indicative of a partial acceptance of a corresponding system function, and a non-acceptance level indicative of a non-acceptance of a corresponding system function.

According to an embodiment the at least one system function is determined based on properties of the technical system and based on at least one technical document assigned to the technical system.

According to an embodiment the at least one technical document assigned to the technical system comprises at least one of the group consisting of a technical specification relating to an intellectual property right, a scientific article, and operation instructions.

According to an embodiment the method comprises determining a match under consideration of at least one predefined relevance criteria.

According to an embodiment the method comprises abstracting the at least one reference function before determining a match between at least one respective technology and the technical system.

According to an embodiment of the present invention, the method of mapping technologies relating to a technical database to a technical system further comprises classifying at least one of the system elements describing the technical system as a peripheral system element (which may in particular interact with an internal system element as well as with the external system element) and at least another one of the system elements as an external system element (which may represent at least a portion of an environment, whereas both the internal system element and the peripheral system element may together represent a device or an arrangement to be further developed or further innovated), wherein the at least one peripheral system element interacts (in particular influences) with the at least one external system element, wherein in particular the at least one external system element is unchangeable.

Further the method may comprise classifiying a further system element of the system elements describing the technical system as an internal system element, wherein the internal system element interacts with the peripheral system element, but the internal system element may not interact with the external system element.

Further, the internal system element as well as the peripheral system element may be changeable, in particular may be changed during performing the method of mapping technologies relating to a technical database to a technical system. In particular, a combination of the at least one internal system element and the at least one peripheral system element may represent a device, an apparatus or an arrangement (which is to be developed or innovated) which is designed to impart a particular intended effect on the environment, in particular on the external system element representing a portion of the environment which is affected by the peripheral system element but which may not be affected by the internal system element.

In particular, the internal interaction function may be separated from or may be distinguished from or may be independent of any influence of the internal system element or the peripheral system element on the external system element. In particular, the external system element may not be affected at all by the internal interaction function. Thereby, changing the internal interaction function may not influence the effect of the peripheral system element on the external system element.

According to an embodiment of the invention, the querying the sets of at least one reference function with regard to the at least one system function allows changing and/or avoiding the internal interaction function. By providing the possibility to change the internal interaction function in particular solutions may be retrieved which lie in a different technological field or which internally use other mechanisms or processes in order to achieve an effect on the external system element which is intended or desired.

According to an embodiment the method of mapping technologies further comprises describing the at least one peripheral system element by at least one intended external function via which the peripheral system element interacts with the at least one external system element or via which the peripheral system element influences the at least one external system element for providing an intended effect on the external system element. In particular, the intended external function may be considered not bound to the peripheral element but may be considered separated from the peripheral system element.

Considering the intended external function separated from other functions in the technical system, such as internal interaction functions, may allow to retrieve solutions for the technology to be innovated which may not be retrieved using a conventional method.

According to an embodiment of the invention, the querying the sets of at least one reference function with regard to the at least one system function further comprises requiring and/or improving the at least one intended external function, in particular without requiring the peripheral system element. Thereby in particular other functions, such as an internal interaction function may not be required and may even be changed or even be avoided. Thereby, novel search strategies may be enabled for retrieving a more comprehensive set of potential solutions for the technology to be innovated or for the technical system to be developed or re-innovated.

According to an embodiment of the invention, the intended external function may be specified or characterized by at least one parameter or at least one parameter range, which may in detail characterize or define the intended external function with respect to an influence on the external system element or on other system elements. For example, the intended external function may be specified regarding a magnitude of a force applied to the external system element. Further, the intended external function may be specified with respect to a heating rate, to a maximal temperature imposed to the external system element, when the intended external function is a heating function. Further, if the intended external function is related to an abrasing or ablating function, the intended external function may be characterized with respect to an ablating rate or abrasing rate, a generated temperature during the ablating or the like.

Further, the intended external function may be imposed by at least one constraint, such as having a restricted or limited influence on the external system element or the environment beyond the external system element, wherein the influence may for example be limited with respect to temperature, load, force, pressure, any mechanical influence or electrical or optical influence.

According to an embodiment of the invention the mapping method further comprises describing the at least one peripheral system element by at least one harmful external function (such as an undesired external function influencing the external element or the environment beyond the external element in an unintended undesired manner) via which the peripheral system element interacts with or influences the external system element in an undesired manner.

In particular, functionally dividing the set of functions performed by the technical system into an internal interaction function, an intended external function and a harmful external function may enable constructing complex queries which may enable retrieving potential solutions for the problem in different technological fields in a more accurate manner.

According to an embodiment of the mapping method, the querying the sets of at least one reference function with regard to the at least one system function is performed in order to reduce the at least one harmful external function. In particular, also the internal interaction function may comprise a harmful internal interaction function, wherein in one embodiment the internal harmful interaction function may be disregarded, while in another embodiment the internal harmful interaction function may be considered, in particular to reduce or to avoid the harmful internal interaction function.

Thereby, a specificity of a query may be improved and a number of hits may be reduced to more reliably find potential solutions or adaptations for the technical system to be developed or re-innovated. According to an embodiment features which have been disclosed in relation to the previous embodiments of a method of mapping technologies or an apparatus of mapping technologies also apply to another aspect of a method of mapping technologies and another aspect of an apparatus of mapping technologies described below. Further, the other aspect of a method of mapping technologies may also be stored on a computer readable data carrier or may be implemented as a program element according to an embodiment.

According to another aspect a method of mapping technologies relating to a technical database to a technical system is provided, wherein the method comprises describing the technical system by at least one function; abstracting the at least one function by determining at least one system function; deriving, for each of a plurality of reference documents of the technical database, a corresponding set of at least one reference function indicative of at least one function of the respective technology; and querying the sets of at least one reference function with regard to the at least one system function to determine a match between at least one respective technology and the technical system, wherein the at least one system function relates the technical system to an environment of the technical system, wherein the at least one function is changeable and the environment is unchangeable.

In particular the at least one function may be an internal function which may be changed or developed by exploring functions from other technological fields, while the system function may relate to an desired external function influencing the environment in an intended manner. The system function may be kept fixed according to an embodiment.

According to another aspect an apparatus for mapping technologies relating to a technical database to a technical system is provided, wherein the apparatus comprises a technical system data input unit adapted for receiving technical system data indicative of at least one function of the technical system abstractly described by at least one system function; a deriving unit adapted for deriving, for each of a plurality of reference documents of the technical database, a corresponding set of at least one reference function indicative of at least one function of the respective technology; and a querying unit adapted for querying the sets of at least one reference function with regard to the at least one system function to determine a match between at least one respective technology and the technical system, wherein the at least one system function relates the technical system to an environment of the technical system, wherein the at least one function is changeable and the environment is unchangeable.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

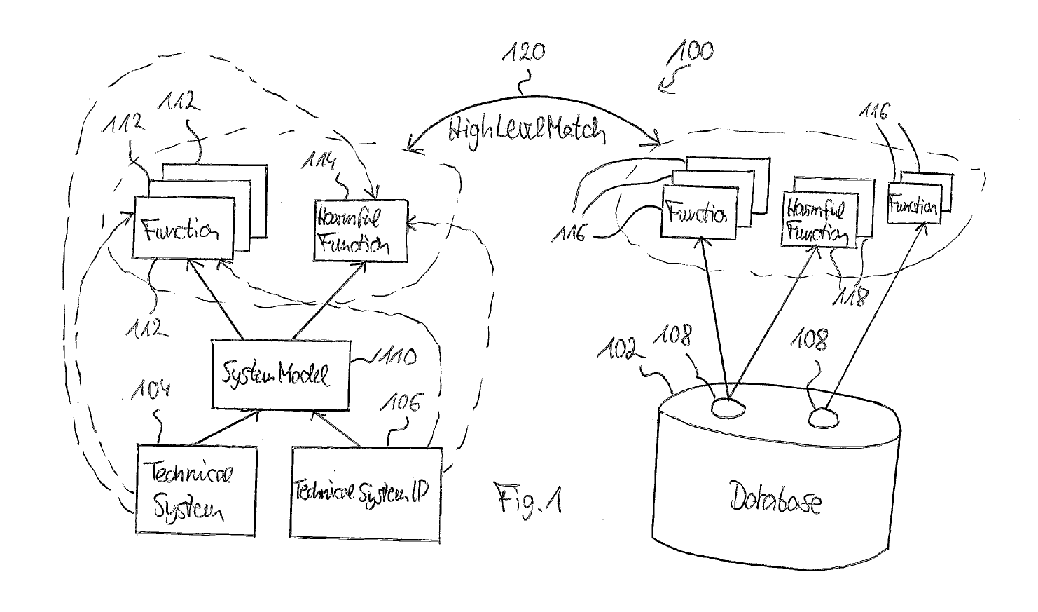

FIG. 1 illustrates a scheme of transferring functions on a higher abstract level for both a technical system and reference technologies as a basis for a matching according to an exemplary embodiment of the invention.

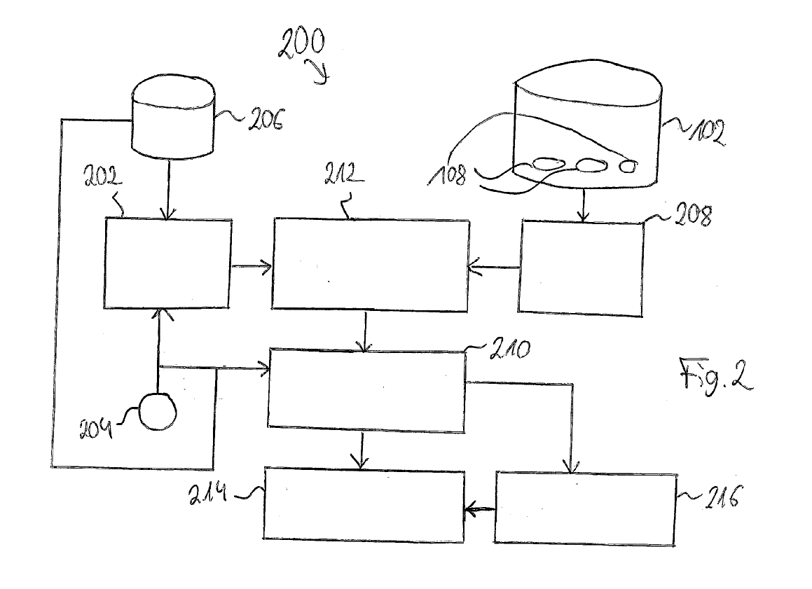

FIG. 2 illustrates an apparatus for mapping technologies according to a technical database to a technical system to be further developed according to an exemplary embodiment of the invention.

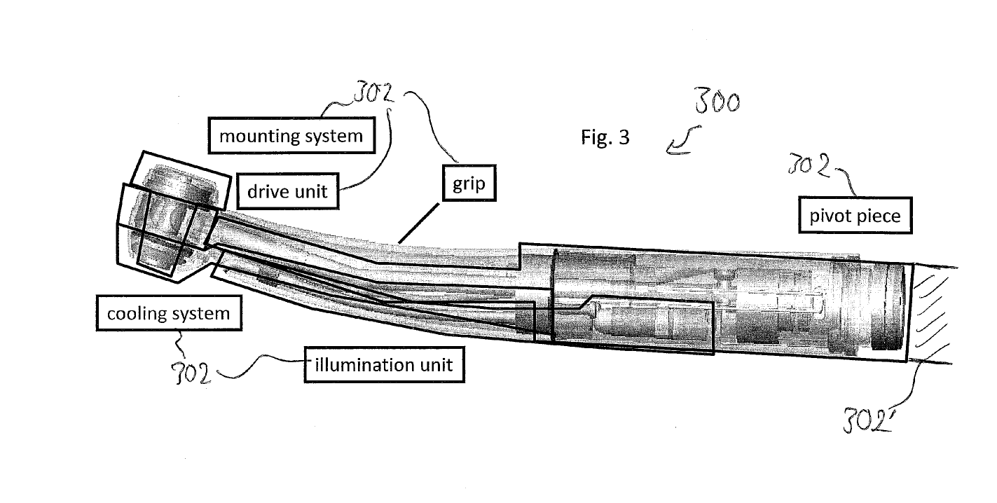

FIG. 3 illustrates a trephine as an example for a technical system to be further developed.

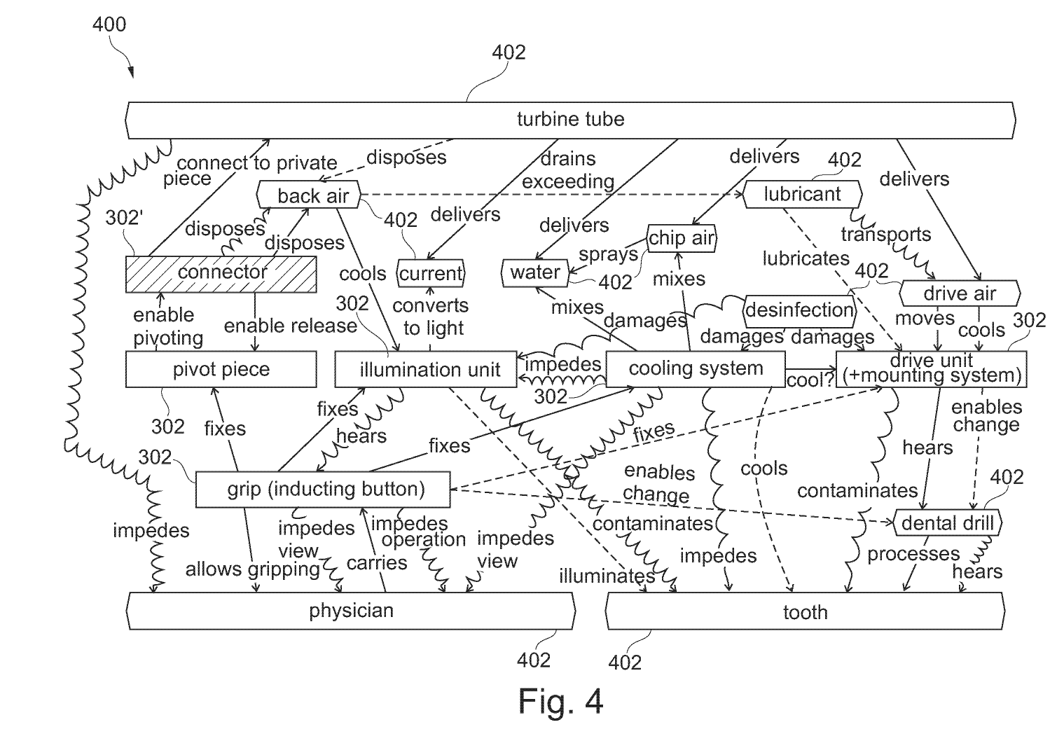

FIG. 4 shows the result of deriving a system model for the trephine of FIG. 3 as a basis for an innovation procedure according to an exemplary embodiment of the invention.

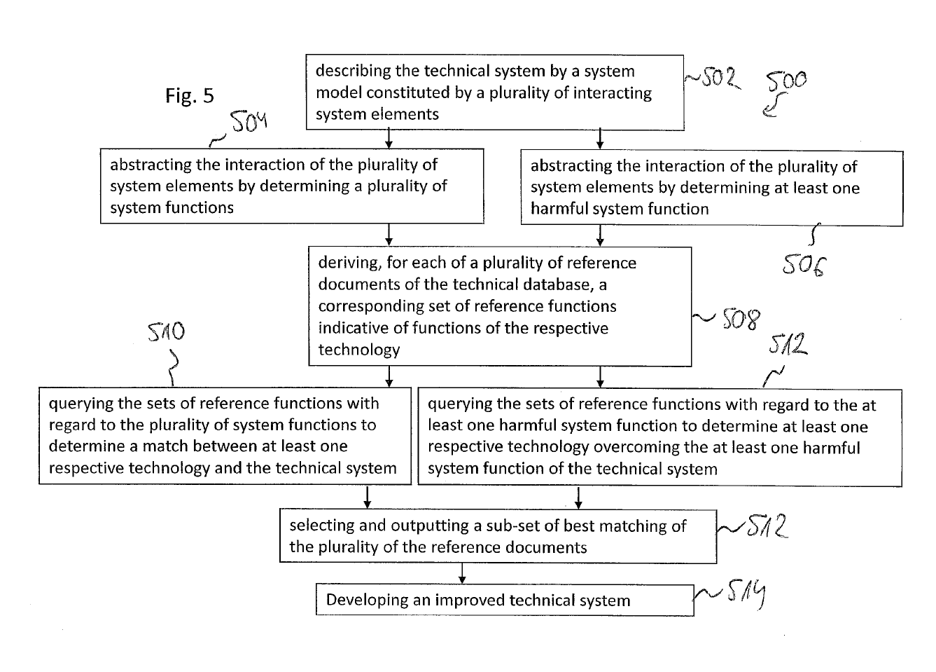

FIG. 5 is a block diagram showing a method of mapping technologies of a technical database to a technical system to be further developed according to an exemplary embodiment of the invention.

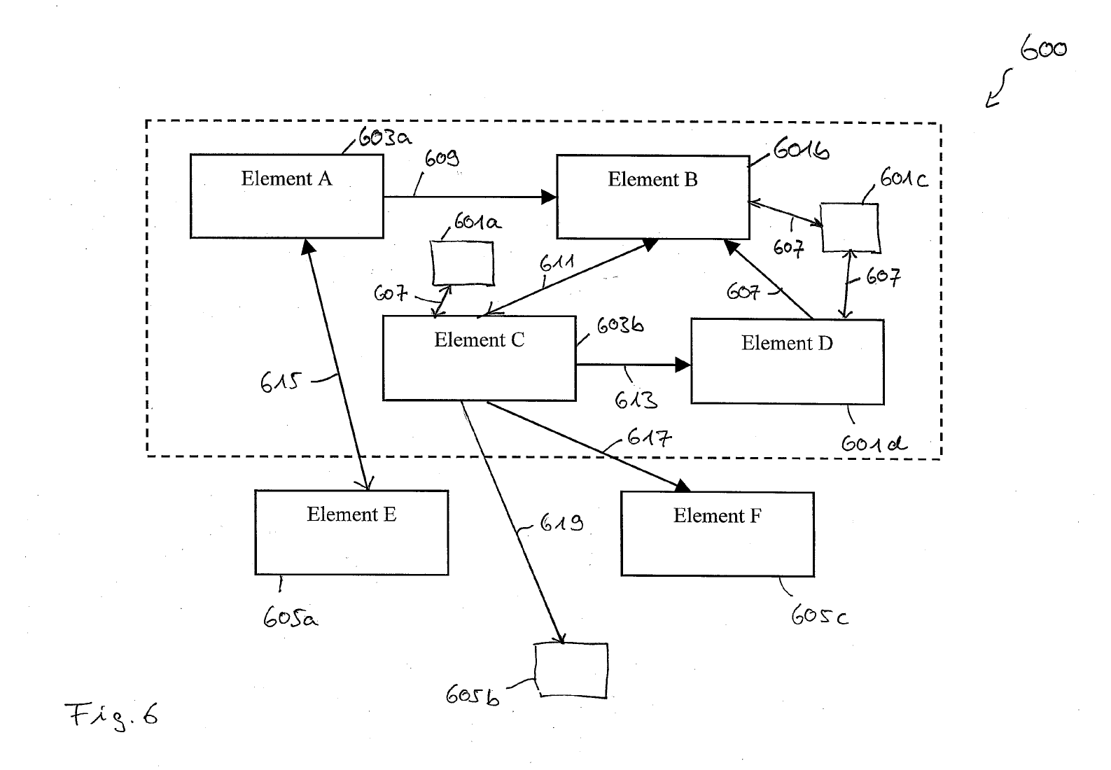

FIG. 6 schematically illustrates a system model for modelling a technical system according to an embodiment of the present invention.

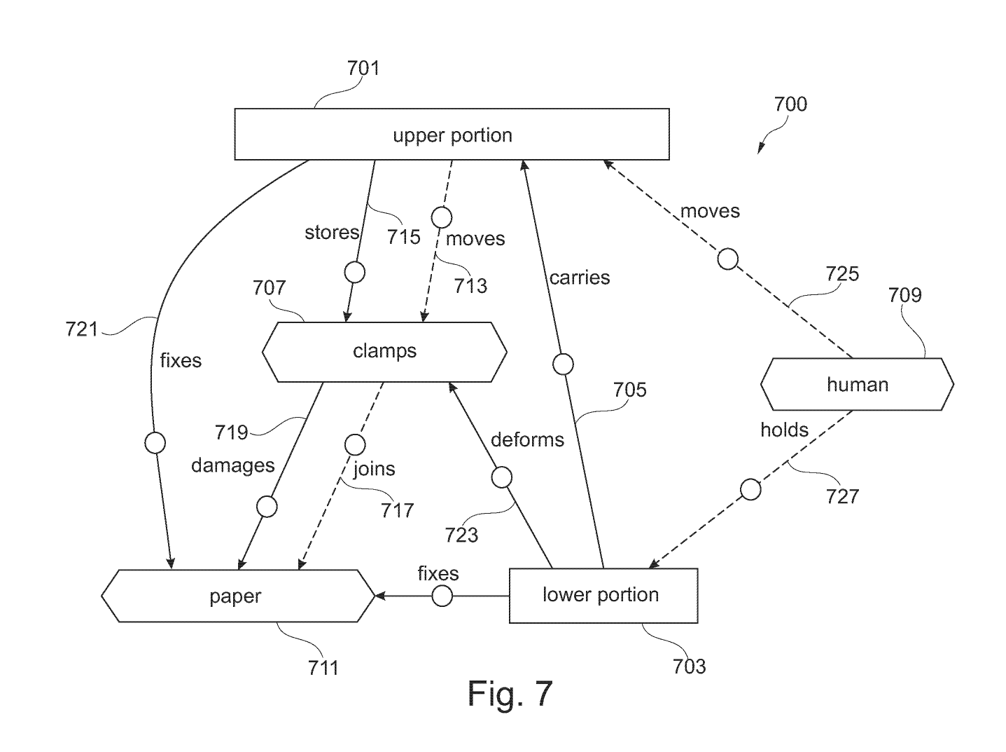

FIG. 7 illustrates a system model of a stapler for modelling a technical system according to an embodiment of the present invention.

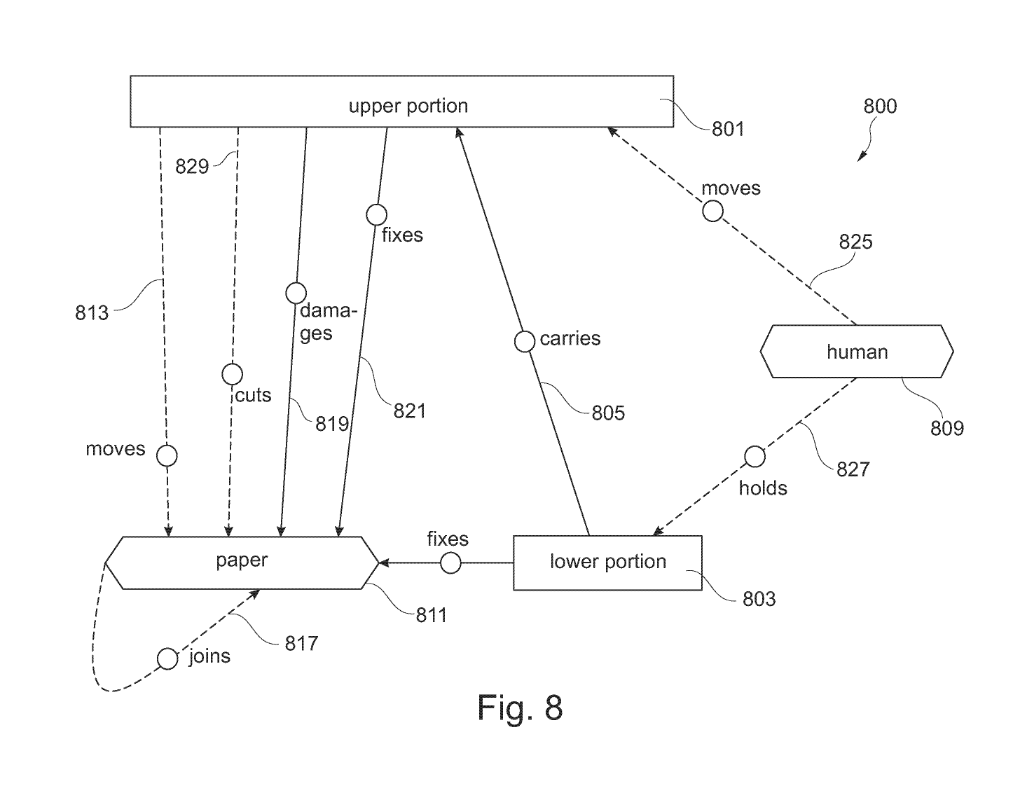

FIG. 8 illustrates a system model of a further developed stapler after modelling the stapler and improving the stapler illustrated in FIG. 7 as a system model.

The illustrations in the drawings are schematical. In different drawings, similar or identical elements are provided with the same reference signs.

Before describing the figures in detail, two exemplary aspects of embodiments of the invention will be briefly mentioned:

According to one aspect, a method of mapping technologies (for instance in an interdisciplinary way) relating to (or documented in) a technical database to a technical system to be further developed is provided. The method comprises describing the technical system by a system model constituted by (i.e. comprising or consisting of) a plurality of interacting (for instance logically coupled) system elements, and abstracting (for instance formulated independent of a specific technology to which the technical system belongs) the interaction (for instance the technical cooperation) of the plurality of system elements by determining a plurality of system functions. The method may further comprise deriving, for each of a plurality of reference documents (for instance electronic reference documents) of the technical database (for instance stored on a storage device), a corresponding set of reference functions indicative of functions of the respective technology. The method may further comprise querying the sets of reference functions with regard to the plurality of system functions to determine a match between at least one respective technology (more precisely between at least one reference document belonging to a respective technology) and the technical system to be further developed.

According to another aspect, an apparatus (for instance a processor-based apparatus such as a computer) for mapping technologies relating to a technical database to a technical system to be further developed is provided. The apparatus comprises a technical system data input unit adapted for receiving technical system data indicative of a system model constituted by a plurality of interacting system elements describing the technical system, wherein the interaction of the plurality of system elements is abstractly described by a plurality of determined system functions. The apparatus comprises a deriving unit adapted for deriving, for each of a plurality of reference documents of the technical database, a corresponding set of reference functions indicative of functions of the respective technology. A querying unit may be provided which may be adapted for querying the sets of reference functions with regard to the plurality of system functions to determine a match (for instance a sufficient level of agreement, for example exceeding a predefined threshold) between at least one respective technology and the technical system to be further developed.

Many alternatives to such concepts are within the scope of the invention. For instance, it is not necessary that a system model including linked system elements is established. It is for instance also possible that any other functional model is constituted or even that one or more functions of the technical system is/are defined as target function(s), regardless whether the technical system is already constructed or not. The technical system may be an existing one which is to be improved or may be a technical system which is to be developed for the future by executing the method/using the apparatus or by using an output of the method/apparatus. Furthermore there may be one or more system functions as well as one or more reference functions.

FIG. 1 is a schematic diagram illustrating a system 100 of mapping technologies relating to reference documents 108 stored in a technical database 102 (which may be a database including IP documents, scientific documents, product-related technical information, etc.) to a technical system 104 to be further developed.

Technical system 104 can be a physical body such as a device which is already existing, for instance in use or commercially available. It is the basis of the industrial system that the technological quality of technical systems such as technical system 104 is successively improved. In the present scenario, an engineer or any other user desires to innovate the technical system 104, i.e. desires to improve its technical functions and to decrease technological harmful functions of the technical system 104. In the present scenario, the technical system 104 is legally protected by technical system IP (intellectual property) rights 106 such as a patent or the like which may be used as an additional source of information for the innovation process.

As can further be taken from FIG. 1, the database 102 (which can be stored on a mass storage device such as a harddisk) can be used to assist the engineer in improving the technical system 104. The database 102 includes a plurality of files each of which being indicative of a corresponding one of the reference documents 108. For example, the shown reference documents 108 may also be IP rights such as patents, or may be other technological disclosures such as scientific papers.

It would be a conventional approach of an engineer seeking to improve the technical system 104 to look for prior solutions from similar technical fields, for example to look for IP rights stored in the database 102 and belonging to the same IPC class as the technical system 104 and the technical system IP right 106. This might allow the engineer to see which kind of further improvements could be possible for a technical system 104.

However, the inventive scheme shown in FIG. 1 takes a fundamentally different strategy. As can be taken from FIG. 1, the technical system 104 as well as the technical system IP 106 are used to define a system model 110. Thus, the technical system 104 and the technical system IP 106 may be analyzed to form a model to describe their technical content by system elements which are coupled to one another by functions, i.e. by certain effects on one of the system elements produced by another one of the system elements. Since the system model 110 is still on a very specific level of abstraction, i.e. describes the system elements of the specific technical system 104 and its corresponding technical system IP 106, it is possible to further abstract the functions for these system elements. A result is shown in FIG. 1 and denoted schematically with a reference numeral 112 and shows a number of system functions 112 of the technical system 104 embedded in a technological environment. However, the technical system 104 and its corresponding technical system IP 106 to be further developed may also show harmful system functions 114, i.e. technological shortcomings, which can be extracted and abstracted in a similar way as performed with the system functions 112. Therefore, the technical system 104 and its corresponding technical system IP 106 are freed from their confined technological specific context and are described by the system functions 112 and the harmful system functions 114 in a more abstract way.

A similar processing is performed with the multiple reference documents 108 in the database 102. They can be analyzed by a search machine of a computer or the like so that also for them functions and harmful functions can be derived which can also be generalized or abstracted to form the abstracted reference functions 116 and optionally harmful reference functions 118. In other words, the reference functions 116 describe the advantageous technical effects of the technology of the corresponding reference documents 108 in an abstract way, whereas the harmful reference functions 118 describe the technological disadvantages in an abstract way.

After the shown transfer of the functions to a higher abstract level, a matching procedure can be performed which is indicated schematically with reference numeral 120. Therefore, it is possible that the individual system functions 112 of the technical system 104 are compared to the corresponding reference functions 116 of the individual reference documents 108. It is also possible that the harmful system functions 114 are considered in conjunction with the reference functions 116 of the reference documents 108 in a manner that such a searching algorithm may look for reference documents 108 which not only fulfill a least a major part of the system functions 112 of the technical system 104 but also overcome at least a part of the harmful system functions 114 of the technical system 104. At the same time, it can be taken into account that a reference document 108 which may be considered for improving the technical system 104 should not involve further harmful functions. This holds particularly for harmful reference functions 118 which have already been overcome by the technical system 104, i.e. are not part of the harmful system functions 114. Therefore, it is a strong bias against assuming a match, if a harmful reference function 118 of a reference document 108 does not correspond to a harmful system function 114 of the technical system 104.

With the described matching procedure performed on an abstract purely functional level, completely new technologies from very different technical fields can be considered by an engineer for an innovation process for improving the technical system 104.

More generally, other embodiments may replace the system model 110 by any other function model, i.e. by any model characterizing the functions of the technical system 104. For instance, the definition of any model may be dispensable if a number of functions 112 and/or harmful functions 114 is defined. The bypass via the system model 110 may then be omitted. This is schematically illustrated by dotted lines in FIG. 1.

FIG. 2 illustrates a computer-based apparatus 200 for mapping reference technologies (corresponding to a technical database 102) to a technical system 104 to be further developed according to an exemplary embodiment of the invention.

The apparatus 200 comprises a technical system data input unit 202 which is adapted for receiving technical system data indicative of a system model constituted by a plurality of interacting system elements describing the technical system 104. Additionally or alternatively, additional kinds of data such as market data may be input via the technical system data input unit 202. The interaction of the plurality of system elements is described by a plurality of determined system functions 112 as well as harmful system functions 114, as illustrated schematically in FIG. 1. Thus, such a system model as shown in FIG. 1 can be input by a user via a user interface 204 to the technical system data input unit 202. The user interface 204 may comprise input elements such as buttons, a keypad, a joystick, an input pen, or even a voice recognition system. Furthermore, it is possible that the user interface 204 includes an output device such as a display, for instance a cathode ray tube, a liquid crystal display, a plasma display or the like.

Additionally or alternatively to the user input 204, it is also possible that data regarding the system model is provided to the technical system data input unit 202 by a technical system database 206. The technical system database 206 can be implemented as a mass storage device, for instance as a harddisk. The technical system database 206 may include data indicative of the system model and/or may allow, for instance based on stored technical documents such as a patent specification, the technical system data input unit 202 to derive a system model based on such input data which may correspond to the technical system IP 106.

Additionally, it is possible that the user interface 204 and/or the technical system database 206 provide(s) one or more relevance criteria to the technical system data input unit 202 and/or to a match determination unit 210 which will be explained below in more detail. Such relevance criteria may define the relevance of certain system functions and/or of harmful system functions of the technical system 104 for consideration when determining potential matches. For example, in case that there is a key function and/or a key harmful function of the technical system 104, a match providing this key function and/or overcoming this key harmful function may be assigned a high relevance value. A match in accordance with a minor function and/or a minor harmful function may be assigned a smaller relevance value.

In parallel to the operation of the technical system data input unit 202, a deriving unit 208 may be arranged for deriving, for at least a part of a plurality of reference documents 108 stored in the database 102, a corresponding set of reference functions indicative of functions of the respective technology assigned to a respective reference document 108. These reference functions can be derived by performing a semantic document analysis by the deriving unit 208. Optionally, the derived reference functions may be abstracted, i.e. generalized to a broader sense. The same can be performed with harmful reference functions which may be mentioned in the reference documents 108 as well, i.e. technological shortcomings or disadvantages of the respective prior art technology.

The functional description of both technical system 104 (optionally in combination with technical system IP 106) as well as reference documents 108 may be supplied to a querying unit 212. The querying unit 212 therefore operates not on a concrete level of technical advantages or disadvantages limited to a specific technical field, but to an abstract formulation thereof. The querying unit 212 is therefore adapted for querying the sets of reference functions with regard to the plurality of system functions to determine a possible match between one or more respective technologies (as represented by the reference documents 108) and the technical system 104 to be further developed. A set of potential candidates for such a match can be forwarded from the querying unit 212 to the match determination unit 210. The match determination unit 210 may use for instance the relevance criteria for deciding whether there is a match, how many matches there are and/or in which order the matches should be output. Although shown as two separate units in FIG. 2, units 210, 212 can also be provided as a common unit, for instance as a common processor.

A technical system modification proposal unit 214 receives the ordered matches from the match determining unit 210. The technical system modification proposal unit 214 may provide the engineer with practical proposals as to how to innovate the technical system in accordance with the matching procedure. For instance it may mention aspects in the matching reference documents 108 which could be a promising basis for innovating the technical system 104. Such proposals may be made in accordance with a degree of agreement of a match.

Optionally, a relevance evaluation unit 216 may determine whether there are relevant IP rights for the technical system 104 among the matching reference documents 108. Relevance in this context may mean that these IP rights could be relevant for the freedom to operate, or also that a possible cross-license could be reasonable. It is also possible that such potentially relevant IP rights are supplied from the relevance evaluation unit 216 to the technical system modification proposal unit 214 so as to enable the technical system modification to be performed in accordance with the IP landscape.

FIG. 3 shows a trephine 300 as an example for a technical system to be further developed. The trephine 300 is functionally decomposed into a number of innovatable system elements 302 which can be modified during the innovation procedure. A connector 302′ is not part of the trephine 300 but can be considered for the innovation because the connector 302′ forms an interface to the environment.

FIG. 4 shows a system model 400 for the trephine 300 which shows the innovatable system elements 302, 302′ as rectangles. Additionally, a number of hexagons 402 are shown in FIG. 4 which illustrate fixed system elements remaining fixed during the innovation process. They relate to peripheral system elements (such as a physician) which cannot be “modified” during an innovation process, since its influence is beyond the design of the technical system. Therefore, the system elements 302 only can be altered, whereas the system elements 402 remain fixed during the innovation process.

The system model 400 of FIG. 4 also shows a number of system functions illustrated as text related to solid lines, waved lines, and dotted lines. The solid lines relate to system functions which are already acceptable, whereas the dotted lines relate to system functions which are only partially acceptable, i.e. could be further improved. An improvement of the solid functions is not required. In contrast to this, harmful functions are shown as waved lines. They relate to undesired functions, i.e. technological disadvantages, of the technical system to be further developed, are unacceptable and need to be improved.

Therefore, reference documents including technical teaching which allows to change a dotted line to a solid line, or reference documents including technical teaching which allows to change a waved line into a dotted line or a solid line are considered as improvements and as promising candidates for improving the technology of the technical system. Furthermore, some of the system functions are underlined in FIG. 4. These correspond to more relevant system functions as the non-underlined ones. In the shown scenario, only the harmful functions are underlined, whereas in other embodiments also the desired functions may be underlined. It is furthermore possible to further refine the distinction between different types of functions (represented by the various lines in FIG. 4). For instance, functions may be distinguished with regard to a degree according to which a task is fulfilled, for instance properly fulfilled, over-fulfilled, or under-fulfilled.

FIG. 5 shows a flow-chart 500 illustrating different blocks of a method of mapping technologies relating to a technological database to a technical system to be further developed, for instance performable by the apparatus 200 shown in FIG. 2. FIG. 5 shows that a describing block 502 can be followed by two abstracting blocks 504, 506 which can be performed simultaneously and allow the abstraction of functions and harmful functions. In a deriving block 508, the reference documents are evaluated and optionally abstracted. Then, in querying blocks 510, 512, the querying with regard to the functions and harmful functions may be performed. In a selecting an outputting block 514, the best matches may be selected and output. A block 516 relates to an improving of the technical system based on the results of block 514.

FIG. 6 schematically illustrates a system model for modelling a technical system according to an embodiment of the present invention. The system model 600 illustrated in FIG. 6 comprises a number of system elements, from which some interact with each other (have mutual influence on each other) and some only have an influence on other system elements.

In particular, the system model 600 comprises internal system elements 601a, 601b, 601c, 601d (which may interact with each other of with peripheral system elements but not with external system elements), peripheral system elements 603a, 603b (which may interact with internal system elements and external system elements) and external system elements 605a, 605b and 605c (representing at least a portion of an environment which is influenced primarily by the peripheral system element), wherein the external system element do not interact with any of the internal system elements. It should be noted, that the internal system elements 601a, 601b, 601c, 601d do not interact with or have an influence on the external system elements 605a, 605b or 605c. Instead, the internal system elements 601a, 601b, 601c, 601d interact with each other or with peripheral system elements via internal interaction functions 607, 609, 611, 613.

Further, at least some of the internal system elements 601a, 601b, 601c and 601d, namely the internal system elements 601b, 601d interact with at least some of the peripheral system elements 603a and 603b. In particular, the internal system element 601b interacts with the peripheral system element 603a via the internal function 609 and the internal system element 601b interacts with the peripheral system element 603b via the internal function 611. Also the internal system element 601d interacts with the peripheral system element 603b via the internal function 613.

According to embodiments of the invention, the internal interaction functions 609 (acting between internal system elements) and also the internal functions between an internal system element and a peripheral system element, i.e. the functions 609, 611 and 613, may be changed in order to innovate or re-develop or further develop the technical system which is modelled using the model 600 illustrated in FIG. 6.

Only the peripheral system elements 603a and 603b have an influence or interact with external system elements 605a, 605b and 605c. In particular, the peripheral system element 603a imposes an intended external function 615 on the external system element 605a and the peripheral system element 603b imposes an intended external function 617 on the external system element 605c. Further, the external system element 605a in turn imposes a reaction onto the peripheral system element 603a (denoted by the double arrow at the intended external function 615). According to embodiment of the mapping method, the external intended function 615 and 617 are maintained for the re-innovated system, since they are intended effects on the external elements 605a and 605c. However, it may not be required to maintain all of the peripheral system elements causing the intended external functions, since the intended external functions could be effected by a novel peripheral system element previously not included. At the same time the internal interaction functions or functions between internal system elements and peripheral system elements may be changed or adapted, as long as the intended external functions 615 and 617 are maintained.

Further, the peripheral system element 603b imposes a harmful external function 619 on the external system element 605b. The harmful external function 617 is undesired and may for example be related to generation of noise, generation of exhaust gas generation of heat or consumption of energy. According to an embodiment of the mapping method, the harmful external function 619 is aimed to be reduced. Therefore, the harmful external function 619 may be introduced when forming a query for querying the technical database.

By classifying (in particular grouping or separating) different kind of system elements, such as by defining internal system elements, peripheral system elements and external system elements and by grouping or separating different kinds of functions between different kinds or same kinds of system elements it is enabled to query the technical database in an improved manner for more accurately retrieve potential solutions for the technical system to be further developed or innovated.

FIG. 7 illustrates a system model 700 of a stapler. In particular, the system model 700 models a mechanical stapler, wherein a peripheral system element “upper portion” 701 interacts with another peripheral system element “lower portion” 703 via an internal interaction function “carries” 705. The peripheral system elements 701, 703 interact with or influence the external system elements “clamps” 707, “human being” 709 and “paper” 711. In particular, the upper portion 701 “moves” (via the external function 713) and “stores” (via the external function 715) the clamps 707. Further, the clamps 707 impose an intended external function “joints” 717 on the paper 711, but the clamps 707 also have a harmful external function “damages” 719 on the paper 711.

Further, the peripheral system element “upper portion” 701 has an neutral external function “fixes” 721 on the external system element “paper” 711, to support the essential intended external function “joins” 717. Further, the peripheral system element “lower portion” 703 has an external function “deforms” 723 on the clamps 707. Further, the system elements 701 and 703 interact via an internal interaction function 705 which does not impose any influence on the external system elements 707, 709 or 711. Further, the human being 709 has harmful external function “moves” 725 on the upper portion 701 and the harmful external function “holds” 727 on the lower portion 703.

The only essential intended external function may be considered to be the function 717 which joins several pages of the paper 711. When querying the technological database this intended external function 717 may be required, while other functions between other system elements may be open for change or may be even avoided at all.

FIG. 8 schematically illustrates a system model of a re-innovated stapler starting from the system model illustrated in FIG. 7.

As can be taken from FIG. 8, the peripheral system elements “upper portion” 801 and “lower portion” 803 have been maintained as well as the external system elements “paper” 801 and “human being” 809. Further, the functions 705, 725, 727 of the basic stapler correspond to the functions 805, 825 and 827 of the re-innovated stapler illustrated as the system model 800 in FIG. 8.

However, the system element “clamps” 707 used in the system model 700 is avoided in the re-innovated stapler according to the system model 800 of FIG. 8. Thereby, the harmful function “damages” 719 imposed on the paper 711 by the clamps 707 can be avoided.

There are a number of functions or interactions between the upper portion 801 and the paper 811. In particular, the essential intended external function “joins” 817 is maintained but is not performed any more by the clamps 707 which are absent in the system model 800 depicted in FIG. 8. To have this essential function 817 it is required that the upper portion 801 further provides the external function “cuts” 829 which was absent in the system model depicted in FIG. 7.

The re-innovated stapler was found by considering the intended external function “joins” 717, 817, in order to improve this function or maintain this function, while harmful functions, such as the function “damages” 719 was aimed to be reduced and also the peripheral system element “clamps” was allowed to be changed or even be avoided.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

Implementation of the invention is not limited to the preferred embodiments shown in the figures and described above. Instead, a multiplicity of variants are possible which use the solutions shown and the principle according to the invention even in the case of fundamentally different embodiments. For instance, although “deriving the functions” and “abstracting the functions” are described herein as two logically separate procedures, it is also possible to combine the deriving and abstracting procedures in one common or simultaneously performed procedure.

1. A method of mapping technologies relating to a technical database to a technical system, the method comprising:
describing the technical system by at least one function;
describing the technical system by a system model constituted by a plurality of system elements;
abstracting the at least one function by determining at least one system function, wherein each of the at least one system function links at least two of the system elements to one another;
deriving, for each of a plurality of reference documents of the technical database, a corresponding set of at least one reference function indicative of at least one function of the respective technology; and
querying the sets of at least one reference function with regard to the at least one system function to determine a match between at least one respective technology and the technical system,

2. The method of claim 1, comprising
describing the technical system by a system model constituted by a plurality of interacting system elements; and
abstracting the interaction of the plurality of system elements by determining the at least one system function.

3. The method of claim 1, wherein the reference documents of the technical database comprise at least one of the group consisting of technical specifications relating to intellectual property rights, scientific articles, operation instructions, and technical specifications accessible via a communications network.

4. The method of claim 1, wherein at least a part of the technologies relating to the technical database are from another technical field, particularly from another International Patent Classification class, more particularly from another International Patent Classification main class, than the technical system.

5. The method of claim 2, wherein the system elements comprise modifiable system elements being modifiable, and comprise fixed system elements remaining fixed.

6. The method of claim 2, wherein the system elements comprise structural system elements indicative of a physical structure of a part of the technical system, and comprise peripheral system elements indicative of a periphery of a physical structure of the technical system.

7. The method of claim 1, comprising:
describing the technical system by at least one harmful function;
abstracting the at least one harmful function by determining at least one harmful system function;
querying the sets of at least one reference function with regard to the at least one harmful system function to determine at least one respective technology overcoming at least one of the at least one harmful system function of the technical system.

8. The method of claim 2, comprising:
abstracting the interaction of the plurality of system elements by determining at least one harmful system function;
querying the sets of reference functions with regard to the at least one harmful system function to determine at least one respective technology overcoming at least one of the at least one harmful system function of the technical system.

9. The method of claim 1, comprising:
deriving, for at least a part of the plurality of reference documents of the technical database, a corresponding set of at least one harmful reference function indicative of at least one harmful function of the respective technology; and
considering the at least one harmful reference function when querying the sets of at least one reference function to determine a match.

10. The method of claim 1, wherein the method comprises adapting the technical system under consideration of at least one technology relating to the determined match.

11. The method of claim 1, wherein the method comprises, when determining a match between at least one respective technology and the technical system, considering a quantity of system functions which do not match to reference functions.

12. The method of claim 1, further comprising:
classifiying at least one of the system elements describing the technical system as a peripheral system element and at least another one of the system elements as an external system element,
wherein the peripheral system element interacts with the external system element, wherein in particular the external system element is unchangeable.

13. The method of claim 12, further comprising:
describing the at least one peripheral system element by at least one intended external function via which the peripheral system element influences the at least one external system element for providing an intended effect on the external system element.

14. The method of claim 12, further comprising:
describing the at least one peripheral system element by at least one harmful external function via which the peripheral system element interacts with the external system element in an undesired manner.

15. The method of claim 14,
wherein the querying the sets of at least one reference function with regard to the at least one system function is performed in order to reduce the at least one harmful external function.

16. An apparatus for mapping technologies relating to a technical database to a technical system, the apparatus comprising:
a technical system data input unit adapted for receiving technical system data indicative of at least one function of the technical system abstractly described by at least one system function;
a deriving unit adapted for describing the technical system by a system model constituted by a plurality of system elements, the deriving unit being further adapted for deriving, for each of a plurality of reference documents of the technical database, a corresponding set of at least one reference function indicative of at least one function of the respective technology; and
a querying unit adapted for querying the sets of at least one reference function with regard to the at least one system function to determine a match between at least one respective technology and the technical system,
wherein each of the at least one system function links at least two of the system elements to one another.

17. A machine-readable medium, in which a program of mapping technologies relating to a technical database to a technical system is stored, which program, when being executed by a processor, is adapted to carry out or control a method according to claim 1.

18. A program element of mapping technologies relating to a technical database to a technical system, which program element, when being executed by a processor, is adapted to carry out or control a method according to claim 1.

19. A method of mapping technologies relating to a technical database to a technical system, the method comprising:
describing the technical system by at least one function;
abstracting the at least one function by determining at least one system function;
deriving, for each of a plurality of reference documents of the technical database, a corresponding set of at least one reference function indicative of at least one function of the respective technology; and
querying the sets of at least one reference function with regard to the at least one system function to determine a match between at least one respective technology and the technical system,
wherein the at least one system function relates the technical system to an environment of the technical system, wherein the at least one function is changeable and the environment is unchangeable.

20. An apparatus for mapping technologies relating to a technical database to a technical system, the apparatus comprising:
a technical system data input unit adapted for receiving technical system data indicative of at least one function of the technical system abstractly described by at least one system function;
a deriving unit adapted for deriving, for each of a plurality of reference documents of the technical database, a corresponding set of at least one reference function indicative of at least one function of the respective technology; and
a querying unit adapted for querying the sets of at least one reference function with regard to the at least one system function to determine a match between at least one respective technology and the technical system,
wherein the at least one system function relates the technical system to an environment of the technical system, wherein the at least one function is changeable and the environment is unchangeable.
